(19) United States
(12) Patent Application Publication
(10) Pub. No.: US 2016/0000131 A1
(43) Pub. Date: Jan. 7, 2016

(54) Methods and Formulations for Enhancing Hydration

(71) Applicant: Gina Bria Vescovi, New York, NY (US)

(72) Inventor: Gina Bria Vescovi, New York, NY (US)

(21) Appl. No.: 14/324,928

(22) Filed: Jul. 7, 2014

(51) Int. Cl. A23L 2/52; A23L 2/39

(52) U.S. Cl. CPC A23L 2/52; A23L 2/39; A23V 2002/00

(57) ABSTRACT

Methods and formulations that incorporate hydrogelic materials are disclosed for enhancing hydration in a body. A hydrogelic material is combined with a liquid in an amount that at least satisfies the absorption capacity of the hydrogelic material. The hydrogelic material captures and encapsulates the liquid and, when ingested by a body, releases the liquid into the body over an extended period of time to provide enhanced hydration. The hydrogelic material is preferably derived from a pulverized hydrogelic source material selected from the group consisting of: chia seeds; flax seeds; konjac root; prickly pear; aloe vera; thia basil; malabar spinach; red algae; Japanese mountain yam; kelp; liquorice root; mallows; okra; parthenium; pinguicula; and slippery elm bark.

### RELATED APPLICATIONS

This application claims the priority benefits of U.S. Provisional Application No. 61/957,691, filed Jul. 11, 2013, which is incorporated by reference in its entirety.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: ©2014 Gina Bria Vescovi, All Rights Reserved.

### TECHNICAL FIELD

The present disclosure relates to the field of hydration, more particularly to methods and formulations for enhancing hydration in humans, animals and plants.

### BACKGROUND

All living organisms on earth require water, and inadequate water levels, i.e., dehydration, can cause a cascade of adverse physiologic problems and sub-optimal body functioning.

Hydration has been the subject of a huge body of research, encompassing the detection of hydration level, the injection of hydration fluid and the retention of hydration fluid. For example, U.S. Pat. Nos. 6,212,959 and 6,558,537 disclose methods of detecting hydration levels and/or means of providing water to the body. U.S. Pat. Nos. 5,876,763, 5,397,785 and 4,322,407 disclose substances, such as glycerols, carbohydrates of specific levels and various types, and electrolytes in various formats, respectively, to promote or enhance the retention of hydration fluid and are generally referenced in terms of beverages.

Athletes have used glycerol for water retention for many years. Dr. K. D. Riedel discovered that drinking glycerol, followed by water, tricks the kidneys and tissues into taking up and holding water by increasing blood osmolarity and then passively flowing into tissues, sucking water into the tissues as well as into all-fluid compartments where water is retained, including in intracellular spaces. Water is thus available to be used by the body over a prolonged period of time. Yet, recently, the United States Olympic Committee has banned the use of glycerol by athletes, citing over (or hyper-) hydration that results from its use.

Two main factors effect the speed at which fluids will enter the body for use to hydrate at the cellular level: the speed at which the fluid empties from the stomach, and the rate at which it is absorbed through the walls of the small intestine. Drinks with 6 to 8% wt carbohydrate content will empty from the stomach at a similar rate as water, whereas research has shown that fluids with a higher carbohydrate content empty at a slower rate. If the drink also contains electrolytes, especially sodium and potassium, the fluid will pass more quickly through the stomach, promoting longer absorption time in the small intestine, encouraging fluid retention in the bolus and reducing urine output.

Electrolytes also play a role in bodily hydration. Interstitial fluid and intracellular fluid have the same osmotic pressure, with the osmotic pressure being primarily regulated in the human body by the concentration of potassium inside the cell and sodium outside the cell. The sodium balance in the human body is principally controlled by two hormones, aldosterone and antidiuretic hormone (ADH). ADH regulates extracellular electrolyte concentration by adjusting the amount of water reabsorbed into the blood from the kidneys, whereas aldosterone regulates extracellular fluid volume by adjusting the amount of sodium reabsorbed into the blood from the kidneys. When the human body sweats, both sodium and water are excreted through the skin, so replacing water alone results in a decreased sodium concentration. A decrease in sodium concentration in the interstitial fluid lowers the interstitial fluid osmotic pressure, resulting in water moving out from the interstitial fluid into the cells. The movement of water from the interstitial fluid into cells can result in two potentially serious problems. The first is cellular hyper-hydration, or over hydration, which can potentially disrupt nerve cell performance leading to various neurological disruption problems such as muscle spasms, convulsions, coma and even death. The second is caused by the accompanying loss of interstitial fluid volume and fluid pressure, which can potentially cause water to move out of the plasma, resulting in loss of blood volume and loss of blood pressure which may lead to symptoms ranging from simple dizziness to profound circulatory shock.

### DETAILED DESCRIPTION

The present disclosure provides methods and formulations for enhancing a body's retention and use of water by taking advantage of the unique properties of hydrogels.

Hydrogels are hydrophilic polymer networks of three-dimensional cross-linked structures that absorb substantial amounts of water, expanding their molecular volume as much as 9-times (perhaps more) while at the same time maintaining dimensional integrity. The cross-linked, interconnected molecular chains form a network that will not only bind water to the hydrophilic sites along the molecular backbone, but will also expand to form cells as the bounded water pushes against the hydrophobic regions of the molecular backbone. These cells allow water and water-soluble molecules to pass through the network. As water enters the network in response to thermodynamic equilibrium principles, the cells expand and will continue to expand until equilibrium is reached between the osmotic pressure to absorb more water and the elastic strength of the cross-linked molecular backbone and cross-linked sites.

Thus, hydrogels capture and encapsulate water in their netlike architecture, which slows the release of liquid substantially, and so retain and release moisture in much the same way as living cells retain and release water in gel form.

Hydrogels have been applied in a diverse variety of products and uses, such as disposable diapers, wound dressings, moisture retention in soils for plantings, breast implants, contact lenses, biomedical implants, tissue engineering, food additive and pharmaceutical formulations. The present disclosure, however, discusses the use of hydrogels within a human, animal or plant body, for the purpose of enhancing internal hydration to improve body systems and to avert or counteract dehydration. The present disclosure can be applied in numerous contexts, including sports performance, military use, animal hydration, and crop irrigation (particularly in areas or during times where fresh water is scarce, making the need for more efficacious ways to use water all the more urgent). The present disclosure has use in enhancing the medical treatment and general health of patient populations that tend to suffer chronic dehydration, such as the elderly. Muscle mass, which is the chief hydration storage site in the body, is lost with age and the body's natural thirst-alert mechanism also diminishes over time, so the elderly typically face a two-front battle to remain adequately hydrated.

One aspect of the present disclosure relates to the use of edible, food safe hydrophilic polymers, such as soluble fiber polysaccharide molecules, cellulose derived molecules, methylcellulose molecules, hyaluronic acid molecules and their derivatives, in hydration-enhancing methods and formulations. The addition of such hydrogel-forming hydrophilic materials to a liquid enhances the hydration efficacy of the liquid and prolongs its hydration effects when ingested. When humans drink water, the water is absorbed into the blood stream relatively rapidly, within approximately 10 minutes. When water is encapsulated in hydrogels, however, it will be held and released from the hydrogel, and so absorbed by the body, over a much longer period of time. The release rate and release profile of water (and of minerals and nutrients dissolved and/or dispersed therein) from the hydrogel matrix depend on a variety of factors, such as the diffusion of water through the bulk matrix and erosion of the matrix by the digestive process, which in turn depend on factors such as the chemical nature of the polymeric matrix, degree of swelling, and cleavable cross-linking density of the matrix. The water concentration gradient between the gel and the surrounding media may also play a role, for example, non-water soluble fibers surrounding the gel may preferentially absorb water released from the gel, thus allowing water to pass from the small intestine into the large intestine rather than be absorbed by the intestine lining The hydrogel matrix also delays gastric emptying, allowing for longer contact time with the intestine walls and prolonging the process of water absorption (as well as mineral and nutrient absorption) in the small intestines.

Thus, combining an edible hydrogelic material with an ingestible liquid provides a means to control the release of liquids into the body, holding the hydration fluids within the intestine for a longer period of time than ingesting the liquid alone. When an edible hydrogelic material-containing formulation according to the present disclosure is ingested with adequate liquid, the liquid is preferentially absorbed by the hydrogelic material in the formulation rather than being absorbed by the stomach or intestine. However, without ingesting adequate liquid, it is believed that the hydrogelic material would pull water from the digestive tract into its cellular structure to form and expand the gel matrix, resulting to a dehydrating effect (rather than a hydrating-enhancing effect) and leading potentially to constipation. The amount of liquid that would be adequate to activate the hydration-enhancing properties of the present formulations depends, in part, on the carbohydrate level of the material. Advantageously, the ratio of hydrogelic material and ingestible liquid can be varied so that some liquid remains free from the gel matrix for immediate absorption by the body.

A preferred source of such edible, food safe hydrophilic polymers is the mucilage from plants or organisms known to have hydrogelic properties, such as: chia seeds (e.g., Salvia hispanica l., Salvia columbariae); flax seeds (e.g., Linum usitatissimum); konjac root (e.g., Amorphophallus konjac); prickly pear (e.g., Optuna humifusa); aloe vera (e.g., Aloe barbadensis); thia basil (e.g., Lamiaceae ocimim basilicum); malabar spinach (e.g., Basell alba); red algae (e.g., Chondrus crispus); Japanese mountain yam (e.g., Dioscorea opposite); kelp (e.g., Fucus vesiculosus); liquorice root (e.g., Glycyrrhiza glabra); mallows (from the Malvaceae family); okra (e.g., Abelmoschus esculentus); parthenium (e.g., Parthenium hysterophorus L.); pinguicula (e.g., Pinguicula vulgarism); or slippery elm bark (e.g., Ulmus rubra). Mucilage in plants and organisms, such as those just listed, is thought to aid in cell membrane thickening and food storage for the plant, more specifically in water storage for seed germination. Natural sources of hydrogelic materials, such as the plants and organisms listed, also may provide various nutritious benefits that are an additional advantage of their use in the hydration-enhancing methods and formulations disclosed here.

Preferably, the hydrogelic source material is pulverized or ground (i.e., its mean particle size reduced), so as to increase the surface area of hydrogelic source material that can be exposed to liquid to form more cellular pockets in which more liquid can be held. For example, plants, seeds and roots, such as those listed above, contain hydrogel forming polymers in small quantities, and pulverizing these types of plant materials exposes more of the soluble and insoluble polymer-containing fibers to be more easily and quickly wetted. Pulverized hydrogelic powders thus can form gel matrices more quickly and can hold more liquid than unpulverized hydrogelic materials and, when used in the hydration formulations discussed in the present disclosure, provide higher levels of hydration. Pulverized hydrogelic powders provide an additional advantage of having a more pleasant mouth feel and so being more readily ingested by humans and animals than unpulverized materials.

For example, 100 grams of chia seeds contains about 40 grams of carbohydrates and about 5 grams of hydrogel-forming polysaccharides. Unground chia seeds will form a gel matrix when added to a liquid, but it has been found that using chia seeds that are pulverized or ground to a mean particle size of 0.003 mm or smaller allows for maximum gel formation with minimal amount of time. In a typical formulation and method according to this present disclosure, 10 grams of pulverized chia seeds is added to 8 ounces of liquid (e.g., water, orange juice, soup, energy drink, sports drink, etc.) or oatmeal, and ingested to provide improvements in hydration over a 2-hour period as can be measured as a total body water (TBW) reading using standard bioelectrical impedance analysis. Eight ounces of liquid for 10 grams of pulverized chia seeds is also more than enough to dilute the carbohydrate content of the fluid mixture so that it empties from the stomach at the same rate as water.

Another aspect of the present disclosure relates the use of pulverized hydrogelic materials, such as the plants and organisms listed above, having more than one mean particle size in the hydration-enhancing methods and formulations disclosed here. The mean particle size of the hydrogelic material affects several of the factors that contribute to the release rate and release profile of liquid from the hydrogel matrix. For example, particles having differing mean sizes will take up water and dissolve at different rates and so release water at different times during the digestive process, which further extends the duration of hydrating potential. Thus, combining materials having more than one mean particle size provides a means to further control the liquid release properties of hydrogels according to this present disclosure.

### EXAMPLE 1

10 grams of chia seeds pulverized to a mean particle size of 0.001 mm is combined with 10 grams of chia seeds pulverized to a mean particle size of 0.003 mm and 8 ounces of water or liquid. The combination of 0.001 mm and 0.003 mm mean particle sizes of chia seeds provides a bi-phasic dissolving rate, with the 0.001 mm particles preferentially releasing liquid in the small intestine and the 0.003 mm particles preferentially releasing liquid in the large intestine, thus extending the duration of the hydration potential of the ingested liquid. Chia seeds may be pulverized or milled by any means known in the art, for example, as discussed in U.S. Patent Publication No. 2010/0310719 (issued as U.S. Pat. No. 8,252,354)

### EXAMPLE 2

5 grams of chia seeds pulverized to a mean particle size of 0.001 mm combined with 5 grams of chia seeds pulverized to a mean particle size of 0.003 mm and 8 ounces of water or liquid.

### EXAMPLE 3

1-ounce (28 grams) of pulverized chia seeds or flax seeds in tablet form, consumed with at least 4 ounces of liquid.

### EXAMPLE 4

Pulverized chia seed combined with liquid in a v/v ratio of 1:9 or more. Chia seeds in liquid expand to form a hydrogel matrix having at least 9-times its original volume. If the liquid volume is 9-times the volume of pulverized chia seeds (having particles of varied sizes), the liquid would be fully absorbed into the pulverized seed, forming a milky, drinkable, higher viscosity liquid. If a higher volume of liquid is added, the added liquid exceeds the hydrogel's absorption capacity and some remains as free (unbound and unencapsulated) liquid. When consumed, the fluid contains two components, a free liquid component that is available for rapid absorption in the stomach, and an encapsulated liquid component that is held within the hydrogel and released over time and further down the digestive tract.

It will be understood that the articles “a”, “an”, “the” and “said” are intended to mean that there may be one or more of the elements or steps present. The terms “comprising”, “including” and “having” are intended to be inclusive and mean that there may be additional elements or steps other than those expressly listed.

The foregoing description has been presented for the purpose of illustrating certain aspects of the present disclosure and is not intended to limit the disclosure. Persons skilled in the relevant art will appreciate that many additions, modifications, variations and improvements may be implemented in light of the above teachings and still fall within the scope of the present disclosure.

I claim:

1. A beverage having enhanced hydration efficacy in a body, comprising:
a hydrogelic material selected from the group consisting of: soluble fiber polysaccharide molecules, cellulose derived molecules, methylcellulose molecules, hyaluronic acid molecules and derivatives thereof, wherein the hydrogelic material is derived from a pulverized hydrogelic source material selected from the group consisting of: chia seeds; flax seeds; konjac root; prickly pear; aloe vera; thia basil; malabar spinach; red algae; Japanese mountain yam; kelp; liquorice root; mallows; okra; parthenium; pinguicula; and slippery elm bark; and
a liquid in an amount that at least satisfies the absorption capacity of the hydrogelic material.

2. The beverage of claim 1, wherein the amount of the liquid includes a portion that is not absorbed by the hydrogelic material.

3. The beverage of claim 1, wherein the pulverized hydrogelic source material has a mean particle size of approximately 0.003 mm or less.

4. The beverage of claim 1, wherein the hydrogelic source material includes a combination of materials having two or more mean particle sizes.

5. The beverage of claim 4, wherein the combination of hydrogelic source material includes a first material having a mean particle size of about 0.003 mm and a second material having a mean particle size of about 0.001 mm.

6. A method of enhancing hydration in a body, comprising:
providing the body with a combination of a liquid and a hydrogelic material selected from the group consisting of: soluble fiber polysaccharide molecules, cellulose derived molecules, methylcellulose molecules, hyaluronic acid molecules and derivatives thereof,
wherein the liquid is in an amount that at least satisfies the absorption capacity of the hydrogelic material and the hydrogelic material is derived from a pulverized hydrogelic source material selected from the group consisting of: chia seeds; flax seeds; konjac root; prickly pear; aloe vera; thia basil; malabar spinach; red algae; Japanese mountain yam; kelp; liquorice root; mallows; okra; parthenium; pinguicula; and slippery elm bark.

7. The method of claim 6, wherein the amount of the liquid includes a portion that is not absorbed by the hydrogelic material.

8. The method of claim 6, wherein the pulverized hydrogelic source material has a mean particle size of approximately 0.003 mm or less.

9. The method of claim 6, wherein the hydrogelic source material includes a combination of materials having two or more mean particle sizes.

10. The method of claim 9, wherein the combination of hydrogelic source material includes a first material having a mean particle size of about 0.003 mm and a second material having a mean particle size of about 0.001 mm.

11. A product for enhancing hydration in a body, comprising:
a formulation comprising a hydrogelic material selected from the group consisting of: soluble fiber polysaccharide molecules, cellulose derived molecules, methylcellulose molecules, hyaluronic acid molecules and derivatives thereof, wherein the hydrogelic material is derived from a pulverized hydrogelic source material selected from the group consisting of: chia seeds; flax seeds; konjac root; prickly pear; aloe vera; thia basil; malabar spinach; red algae; Japanese mountain yam; kelp; liquorice root; mallows; okra; parthenium; pinguicula; and slippery elm bark; and
a printed instruction to combine the formulation with at least 4-ounces of a liquid prior to ingestion.

12. The product of claim 11, wherein the formulation comprises a powder.

13. The product of claim 11, wherein the formulation comprises a tablet.

14. The product of claim 11, wherein the pulverized hydrogelic source material has a mean particle size of approximately 0.003 mm or less.

15. The product of claim 11, wherein the hydrogelic source material includes a combination of materials having two or more mean particle sizes.

16. The product of claim 15, wherein the combination of hydrogelic source material includes a first material having a mean particle size of about 0.003 mm and a second material having a mean particle size of about 0.001 mm.

17. The product of claim 16, wherein the first and second materials are chia seeds.
